(19) United States
(12) Patent Application Publication
(10) Pub. No.: US 2025/0024554 A1
(43) Pub. Date: Jan. 16, 2025

(54) RESOURCE CONFLICT AVOIDANCE IN A SIDELINK RESOURCE POOL

(71) Applicant: Robert Bosch GmbH, Stuttgart (DE)

(72) Inventors: Khaled Shawky Hassan, Sarstedt (DE); Maximilian Stark, Hamburg (DE)

(21) Appl. No.: 18/711,147

(22) PCT Filed: Nov. 23, 2021
(86) PCT No.: PCT/EP2021/082647

§ 371 Date: May 17, 2024

(51) Int. Cl. H04W 76/28; G01S 13/76; H04W 52/02

(52) U.S. Cl. CPC H04W 76/28; G01S 13/76; H04W 52/0216

(57) ABSTRACT

A wireless communication method of a first radio node, for obtaining a position reference signal from at least a second radio node, based on a discontinuous reception pattern of at least the second radio node. The method includes: generating, at the first radio node, at least one ranging request; and transmitting the at least one ranging request comprising at least one position calculation indication to at least the second radio node such that at least the second radio node receives the at least one ranging request (SPRS) during an active reception period of at least the second radio node, wherein the active reception period of at least the second radio node is defined by a discontinuous reception pattern of at least the second radio node.

### FIELD

The present invention relates to methods for obtaining a position reference signal at a first radio node from at least a second radio node, based on a discontinuous reception pattern of at least the second radio node, and associated apparatuses, systems, computer program elements, computer readable media, and a vehicle.

### BACKGROUND INFORMATION

Connected mobility is the subject of a variety of communication standards such as IEEE 802.11p/bd and 3GPP LTE/NR vehicle-to-everything (shortened in this specification to “V2X”). Two scenarios are considered for V2X—that User Equipment (UE) can be within communication range of a base station (BS) such as an evolved-Node BS (eNB) or a 5G-NR-Node BS (gNB), or out of communication range. Another scenario is that a set of UEs that are connected together may be connected to the network, and the other set of the UEs that are connected together may be out of network coverage. This is referred to as partial out of coverage.

Typically, when a UE (for example, UE mounted in a vehicle) is in coverage, the UE can be configured to perform sidelink communication with other UEs in range. In this case, resource allocation, data control, and communication procedures are controlled by the UE. In the case that a UE is out of coverage of, for example, EUTRA or 5G-NR cells, the UE is pre-configured with mandatory configuration for autonomous communication using the sidelink. In example, a UE can be pre-configured with a number of out-of-coverage frequencies and corresponding communication time-frequency resource pools. As an example, the out-of-coverage frequencies may include the Intelligent Transport System (ITS) frequencies.

In order that UEs can select sidelink resources, V2X provides for two operation modes for performing resource assignment. Mode one is controlled by the network. UEs are either dynamically granted sidelink resources that they request via the network, or are periodically configured with semi-persistent sidelink resources. Mode two enables UEs to select their resources autonomously based on respective needs of each UE from configured (or pre-configured) time and frequency resources referred to as shared resource pools.

Typically, when a UE (for example, UE mounted in a vehicle or a bicycle) is in coverage, the UE can be configured to perform sidelink communication with other UEs in range. In this case, resource allocation, data control, and communication procedures are controlled by the UE. In the case that a UE is out of coverage of, for example, EUTRA or 5G-NR cells, the UE is pre-configured with mandatory configuration for autonomous communication using the sidelink. In example, a UE can be pre-configured with a number of out-of-coverage frequencies. As an example, the out-of-coverage frequencies may include the Intelligent Transport System (ITS) frequencies.

V2X mode one requires the UEs to have network coverage. Mode two may be configured during a time when the UEs possess network coverage. When at least one UE is out of network coverage, mode two is, for example, automatically selected enabling at least one UE to select its own sidelink resources from the preconfigured shared resource pool.

FIG. 1 schematically illustrates an example of a radio network 8. In this example, the network comprises a “V2X” configured sidelink utilising mode 1 and mode 2, although it will be appreciated that the scenario of FIG. 1 may be extended to other radio standards using a sidelink between radio nodes that are out of coverage.

Region 10 is outside of network coverage provided by a BS. Region 12 is a region of partial coverage. Region 14 is in coverage. UE1 is a radio node that communicates with UE2 via a sidelink channel in mode 2, for example. UE3 communicates from the region of partial coverage to an out-of-coverage UE4 via the sidelink channel in Mode 2. UE5 communicates with UE6 via a sidelink channel in mode 1, as configured by control information Uu from the BS.

Identifying the position of a radio node with respect to another radio node is of interest in many scenarios. Wireless standards such as 3GPP Release 16 enable the UE to be configured with a downlink Position Reference Signal (PRS) having a high resource element (RE) density that is suitable for positioning calculations. The patterns of the PRS are referred to as combs, and are typically defined by the distance between two PRS REs, and an offset over time. Positioning approaches in 3GPP mobility scenarios may, however, be further improved.

### SUMMARY

According to a first aspect of the present invention, there is provided a wireless communication method of a first radio node, for obtaining a position reference signal from at least a second radio node, based on a discontinuous reception pattern (DRX) of at least the second radio node. According to an example embodiment of the present invention, the method comprises:
generating, at the first radio node, at least one ranging request (SPRS); and
transmitting the at least one ranging request (SPRS) comprising at least one position calculation indication to at least the second radio node such that at least the second radio node receives the at least one ranging request (SPRS) during an active reception period of at least the second radio node, wherein the active reception period of at least the second radio node is defined by a discontinuous reception pattern of at least the second radio node.

Therefore, a ranging radio node may more accurately track the position of the ranged radio nodes, whilst the ranged radio nodes can save energy whilst being ranged by the ranging radio node. Therefore, the power consumption of the ranged radio nodes is reduced whilst undergoing ranging by the ranging radio node. The battery life of the ranged radio nodes may be extended.

According to a second aspect of the present invention, there is provided a wireless communication method of a second radio node, for transmitting a position reference signal to at least a first radio node based on at least one of a discontinuous reception and/or a discontinuous transmission pattern of at least the second radio node. According to an example embodiment of the present invention, the method comprises:
receiving at least one ranging request (SPRS) comprising a position calculation indication from the first radio node during an active reception period of the second radio node, wherein the active reception period is defined by a discontinuous reception pattern of the second radio node; and
transmitting at least one position reference signal (PRS) to the first radio node in a resource of a side link resource pool in response to receiving the ranging request (SPRS) from the first radio node.

According to a third aspect of the present invention, there is provided a method for obtaining a position reference signal from at least a second radio node, based on a discontinuous reception pattern of at least the second radio node. According to an example embodiment of the present invention, the method comprises:
generating, at the first radio node (UE1), at least one ranging request (SPRS);
transmitting, from the first radio node, at least one ranging request (SPRS) comprising at least one position calculation indicator to at least the second radio node such that at least the second radio node receives the at least one ranging request (SPRS) during an active reception period of at least the second radio node, wherein the active reception period of at least the second radio node is defined by a discontinuous reception pattern of at least the second radio node;
receiving, at the second radio node, the at least one ranging request (SPRS) from the first radio node during an active reception period of the second radio node, wherein the active reception period is defined by a discontinuous reception pattern of the second radio node; and
transmitting, from the second radio node, at least one position reference signal (PRS) to the first radio node in a resource of a side link resource pool in response to receiving the ranging request (SPRS) from the first radio node.

According to a fourth aspect of the present invention, there is provided a first radio node. The first radio node comprises a radio modem, non-transitory computer readable media comprising machine readable instructions, and a processor configured to load and to execute the machine readable instructions to cause the first radio node to execute the steps according to the first aspect or its embodiments, and thus to transmit a modified position reference signal to a second radio node via at least one side link channel.

According to a fifth aspect of the present invention, there is provided a second radio node. According to an example embodiment of the present invention, the second radio node comprises a radio modem, non-transitory computer readable media comprising machine readable instructions, and a processor configured to load and to execute the machine readable instructions to cause the second radio node to execute the steps according to the second aspect, or its embodiments.

According to a sixth aspect of the present invention, there is provided a system for radio communication. According to an example embodiment of the present invention, the system comprises a first radio node and a second radio node. The first radio node is configured to generate at least one ranging request comprising at least one position calculation indication, and to transmit at least one ranging request including at least one positioning calculation indication to at least the second radio node such that at least the second radio node receives the at least one ranging request during an active reception period of at least the second radio node, wherein the active reception period of at least the second radio node is defined by a discontinuous reception pattern of at least the second radio node. The second radio node is configured to receive the at least one ranging request (SPRS) comprising the position calculation indicator from the first radio node during an active reception period of the second radio node, wherein the active reception period is defined by a discontinuous reception pattern of the second radio node, and to transmit at least one position reference signal (PRS) to the first radio node in a resource of a side link resource pool in response to receiving the ranging request (SPRS) from the first radio node.

According to a seventh aspect of the present invention, there is provided a computer program element comprising machine readable instructions which, when loaded and executed by a processor, cause the processor to perform the method according to the first aspect of the present invention or its embodiments.

According to an eighth aspect of the present invention, there is provided there is provided a computer program element comprising machine readable instructions which, when loaded and executed by a processor, cause the processor to perform the method according to the second aspect of the present invention or its embodiments.

According to a ninth aspect of the present invention, there is provided non-transitory computer readable media comprising the machine readable instructions defined by one the seventh or eighth aspects of the present invention.

According to a tenth aspect of the present invention, there is provided a vehicle, comprising a radio communication node according to one of the fourth or fifth aspects of the present invention.

The example embodiments of the present invention discussed herein may be applied to location-finding between at least two radio nodes according to 5G use cases discussed in TR 22.872, such as location-based services using accurate positioning between vehicles or bicycles, industry-related use cases such as waste management and collection, e-Health related use cases such as locating medical equipment in hospitals, emergency-services related applications, road-related use cases such as road-user charging, rail and maritime-related use cases, such as freight tracking, and aerial-related use-cases such as unmanned aerial vehicle missions and operations. In this specification, the term “radio node” is interchangeable with the signifier “UE”.

### BRIEF DESCRIPTION OF THE DRAWINGS

Exemplary embodiments of the present invention are depicted in the figures, which are not to be construed as limiting the present invention, and are explained in greater detail below.

FIG. 1 schematically illustrates an example of a “V2X” configured system comprising a sidelink that can be configured into mode 1 and mode 2.

FIG. 2 schematically illustrates an example of time and frequency resource configuration of the sidelink in mode 2.

FIG. 3 schematically illustrates the time-frequency distribution of DRX and DTX resources in a sidelink.

FIG. 4 schematically illustrates a method of a first radio node, according to an example embodiment of the present invention.

FIG. 5 schematically illustrates a method of a second radio node, according to an example embodiment of the present invention.

FIG. 6A schematically illustrates a method of a ranging request and response during a DRX cycle, according to an example embodiment of the present invention.

FIG. 6B schematically illustrates a wakeup of a ranged UE upon reception of a ranging request, according to an example embodiment of the present invention.

FIG. 7 schematically illustrates a first exemplary ranging signalling scheme, according to the present invention.

FIG. 8 schematically illustrates a second exemplary ranging signalling scheme, according to the present invention.

FIG. 9 schematically illustrates a third exemplary ranging signalling scheme, according to the present invention.

FIG. 10 schematically illustrates an example of first and second radio nodes, according to the present invention.

FIG. 11 schematically illustrates an example of a ranging method of at least first and second radio nodes, according to the present invention.

### DETAILED DESCRIPTION OF EXAMPLE EMBODIMENTS

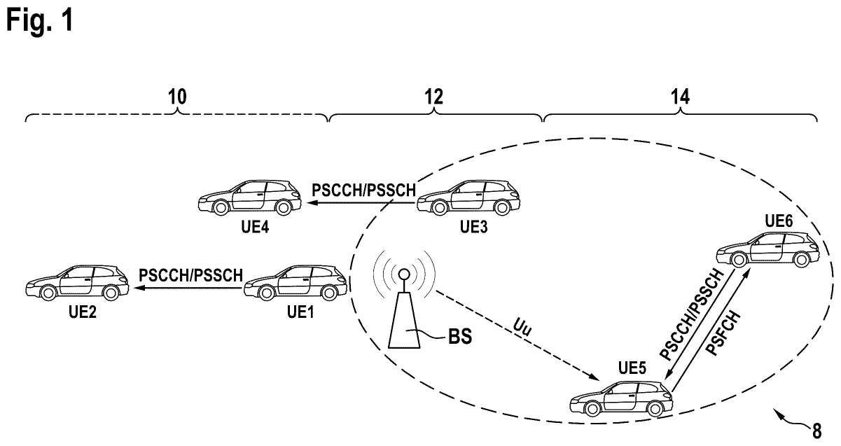

FIG. 1 schematically illustrates an example of a “V2X” configured system comprising a sidelink that can be configured into mode 1 and mode 2.

The radio standard 5G New Radio (5GNR) provides for a network comprising a next generation node base station (gNB) and a set of User Equipment (UE1, UE2 . . . ). The gNB is used for controlling of communicating data to some, or all of the UEs via the Uu interface. The Uu interface may be considered to be a communication link between a gNB and another network terminal UE. In examples, the UE terminal (also referred to herein as a radio node) may be an IoT device, a vehicular infrastructure element, an industrial automation component, or an industrial infrastructure element. Examples of vehicular infrastructure elements are traffic lights, and streetlights. Examples of an industrial infrastructure element are robots or industrial machines. The UE terminal may be a mobile telephone, laptop computer, tablet, smartwatch, or the like. The UE terminal may be embodied within a vehicle such as an automobile, heavy goods vehicle, bicycle, and the like.

The 3GPP standard provides for the transmission of signals between first and second radio nodes enabling the second radio node to determine its position relative to a first radio node, for example. The signals are typically referred to as “combs” owing to their structure in frequency and time. The first radio node UE1 may be requested by the second radio node UE2 to transmit a position reference signal (PRS) having a comb structure known at the second radio node UE2. When the second radio node UE2 receives the requested PRS from the first radio node, a decoding technique such as downlink angle of departure (DL-AoD), uplink angle of arrival (UL-AoA), Round Trip Time (RTT), downlink Time of Arrival (DL-ToA) or uplink Time of Arrival (UL-ToA) may be applied by the second radio node UE2 to the PRS transmitted by the first radio node UE1. This enables the second radio node UE2 to determine its position relative to the first radio node UE1.

Current implementations of positioning using the PRS only support positioning for classical cellular scenarios, such as positioning between the gNB (base station, BS) and mobile radio nodes UE. Vehicular and industrial applications, when out of coverage (or in partial coverage) of a gNB (base station, BS) require inter-UE positioning without involving the gNB. The present specification details an approach for using the PC5 sidelink to support inter radio-node positioning.

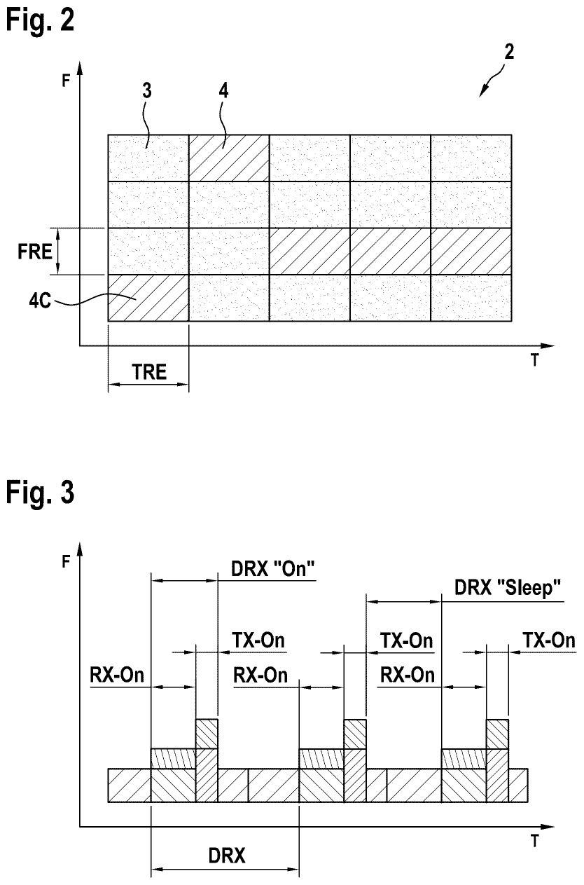

FIG. 2 schematically illustrates an example of time and frequency resource configuration of the sidelink in mode 2.

The sidelink resource allocation 2 in mode 2 is divided into frequency resource blocks (ranges of subchannels) FRE and time slots TRE. In an example, a subset 3 of the sidelink resource allocation in mode 2 is configured by the gNB. Another subset 4 of the resource allocation is dedicated to autonomously used resources accessed by the radio nodes UE. In an example, one or more UEs may use semi periodic scheduling of the sidelink resource allocation 2 to contend for sidelink resources. In mode 2, resources can be allocated as a one-shot transmission, where the UE transmits into the gNB controlled resource or the autonomously allocated resource as a MAC-PDU because available. In another example, configured sidelink resources may enable a UE to transmit multiple MAC-PDUs on multiple transmission opportunities.

### Position Reference Signals

3GPP, release 16, proposed Position Reference Signal configurations, for example, defining the structure of a PRS signal during the downlink and/or uplink between UE and a gNB (BS). The Position Reference Signal configuration also defines on which OFDM symbol and subcarriers the PRS may be found. A PRS positioning frequency layer is defined as a collection of PRS resource sets with each PRS resource set defining a collection of PRS resources. When applied to localisation between a radio node such as a gNB and a radio node such as item of user equipment UE5, one or more downlink Position Reference Signals are used at UE5 transmitted from the gNB (BS). The 3GPP release 16 PRS has a high resource element density having a diagonal or staggered PRS pattern and correlation properties that are better than existing reference signals.

For example, in the “New Radio” NR standard, a downlink PRS can be configured within a slot, or at a multi slot level. Within a slot, the resource element defining the start of the PRS comb (time and frequency) can be chosen. Gaps, periodicity, and density of multi-slot PRS signals can be configured. The PRS may be transmitted in beams. This specification concerns details of when to transmit the PRS, rather than the signal structure of the PRS. Therefore, a skilled person will appreciate that all possible PRS signal structures may be applied in combination with the techniques discussed in this specification.

Ranging UE1 transmitting SPRS based on the DRX cycle status of the ranged UEs

Based on their energy capabilities, sidelink devices can be configured to enter an efficient power saving mode. In that case, a UE1 localizing another UE2 via the sidelink could send a sidelink PRS that cannot be received, or responded to, by another UE in power saving mode. Therefore, it is proposed in this specification that, for example, the ranging UE1 should perform a ranging attempt to power saving devices only if one or more UEs receiving the sidelink PRS are listening. Whether or not this is the case is defined by the discontinuous reception cycle DRX of the one or more UEs intended to receive the sidelink PRS. In other words, it is proposed that the ranging UE1 should attempt to match the discontinuous reception cycle DRX of the one or more UEs being ranged. In one example, the ranging UE1 may transmit at least one SPRS request synchronized to the DRX cycle of the ranged UE2. In another example, the ranging UE1 may transmit at least one SPRS request synchronized to the DTX cycle of the ranged UE2. In another example, the ranging UE1 transmits a wake up signal to a sleeping ranged UE2. In another example, the ranging UE1 transmits a wake up signal to a sleeping ranged UE2, and the ranged UE2 transmits a SPRS response (containing a position reference signal) to ranging UE1 in response to the wake up signal.

In other words, a ranging UE1 may more accurately track the position of the ranged UEs, whilst the ranged UEs can still save power whilst being ranged. Therefore, the power consumption of the ranged UEs is reduced whilst undergoing ranging by the ranging UE. The battery life of the ranged UEs may be extended.

For example, in contrast to Uu communication (between a base station BS and a radio node UE), many sidelink use cases directly address the communication between vulnerable users and vehicles. By enabling efficient positioning techniques over the sidelink, the protection of these vulnerable users can be largely improved. However, devices used in this context might be mounted on a bicycle, u-mobility device, or the handheld device of a pedestrian. All these devices have strict energy constraints.

### DRX Operation Mode of User Equipment

As specified in TS 38.213, RRC controls DRX operation by configuring the following parameters:

| Parameter | Function |
|---|---|
| drx-onDurationTimer | the duration at the beginning of a DRX Cycle; |
| drx-SlotOffset | the delay before starting the drx- |
| | onDurationTimer; |
| drx-InactivityTimer | the duration after the PDCCH |
| | occasion in which a PDCCH indicates |
| | a new UL or DL transmission for the |
| | MAC entity; |
| drx- | the maximum duration until a DL |
| RetransmissionTimerDL | retransmission is received; |
| drx- | the maximum duration until a grant |
| RetransmissionTimerUL | for UL retransmission is received; |
| drx- | the Long DRX cycle and drx- |
| LongCycleStartOffset: | StartOffset which defines the |
| | subframe where the Long and Short |
| | DRX Cycle starts; |
| drx-ShortCycle | the Short DRX cycle; |
| drx-ShortCycleTimer | the duration the UE shall follow the |
| | Short DRX cycle; |

When a DRX cycle is configured, the Active Time of the UE includes the time while drx-onDurationTimer or drx-InactivityTimer or drx-RetransmissionTimerDL or drx-RetransmissionTimerUL are running, or a scheduling request is sent on the PUCCH.

FIG. 3 schematically illustrates the time-frequency distribution of DRX and DTX resources in a sidelink. For a proportion of the time, a UE is able to receive an SPRS request (sidelink position reference signal request) during the “RX-On” periods. For a proportion of the time, a UE is able to transmit an SPRS response comprising a position reference signal comb pattern used for ranging during the “TX-On” periods.

In embodiments, the “RX-On” periods may be defined by the same “DRX” cycle, which in practice is useful because a transmission from a UE will be usually closely associated with a reception at the same UE (especially when considering the needs of HARQ feedback to the transmitting UE. “TX-On” periods may be defined by an associated DTX cycle. The DTX-period (the time where the UE is on and able to transmit) and DRX-period (the time where the UE is on and able to receive) may overlap, or may be separated in time. When considering Uu communications, the gNB schedules the uplink, and thus there is no need to configure DTX separately from UL grants. However, when considering sidelink communications, DTX is the selected time for transmission (selection window). This is a result of the channel sensing procedure in a partial time window, for example, during RX-on or DRX-on.

Furthermore, because the mode 2 sidelink is decentralized, a common DRX cycle configuration affecting all UEs in a given group is often beneficial. Configuring the sidelink DRX comprises defining a time slot offset “drx-SlotOffset” and a periodic monitoring time for monitoring data transmission and reception. In a group of UEs, if the corresponding sidelink DRX configuration is preconfigured for all UEs, a ranging UE1 will know when to transmit an SPRS request to UE2, and the ranged UE2 will know when to respond to UE1 with its SPRS. In FIG. 3, the RX-On and TX-On periods may be added to form a DRX “On” period, and an associated DRX “sleep” period. The DRX cycle “DRX” is also illustrated. In some embodiments, the transmit and receive functionality of a UE is enabled in the DRX “On” cycle, and disabled in the DRX “sleep” cycle. In other embodiments, the Rx and Tx function of each UE are separately defined using RX “On” and Tx “On”. Without DRX cycle alignment between UEs participating in ranging operations, it is not possible for all UEs to participate in ranging without the risk that a ranged UE will be asleep when it receives an SPRS request.

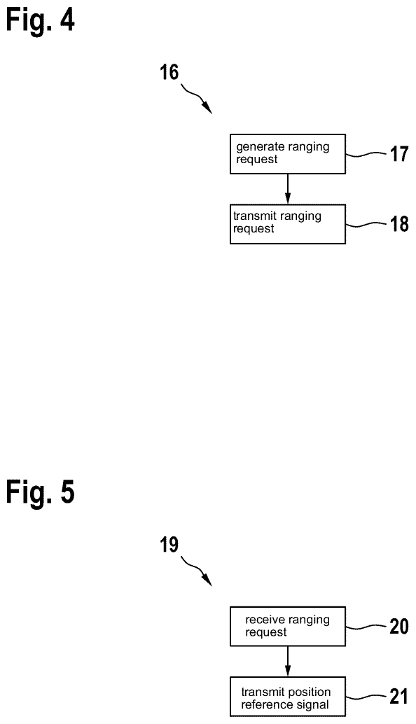

FIG. 4 schematically illustrates a method of a first radio node.

According to a first aspect, there is provided a wireless communication method 16 of a first radio node UE1, for obtaining a position reference signal from at least a second radio node UE2, based on a discontinuous reception pattern DRX of at least the second radio node The method comprises:
generating 17, at the first radio node, at least one ranging request (SPRS); and
transmitting 18 the at least one ranging request (SPRS) comprising at least one position calculation indication to at least the second radio node such that at least the second radio node receives the at least one ranging request (SPRS) during an active reception period of at least the second radio node, wherein the active reception period of at least the second radio node is defined by a discontinuous reception pattern of at least the second radio node.

The position calculation indication is, for example, a bit, flag, or other data signifier comprised in data transmitted from UE1 to the ranged UE2 that the transmission from the ranged UE2 to the ranging UE1 should comprise a PRS pattern in the sidelink to enable ranging.

For example, if the exact DRX and/or DTX cycles are known to the ranging radio node UE1, UE1 shall send the ranging SPRS comprising the position calculation indication to one or more further radio nodes to be ranged when the one or more further radio nodes are in a DRX active time, so that the one or more further radio nodes can receive the ranging SPRS comprising the position calculation indication. In an embodiment, the ranging radio node UE1 may know a subset of all available DRX cycles. In this case, the ranging radio node UE1 may transmit the ranging SPRS on one of the known subset of DRX active periods.

In examples, the at least one ranging request SPRS is transmitted from the first radio node UE1 to the second radio node via a resource of a side-link resource pool. In examples, the at least one ranging request is transmitted from the first radio node UE1 to at least the second radio node UE2 via a message in the physical side-link control channel PSCCH. In examples, the at least one ranging request is transmitted from the first radio node UE1 to at least the second radio node UE2 via a message in the physical side-link broadcast channel PSBCH. In examples, the position reference signal is received by the first radio node UE1 from at least the second radio node UE2 via a resource of a side-link resource pool.

In examples, the position reference signal is received by the first radio node UE1 from at least the second radio node UE2 via a message in the physical side-link shared channel PSSCH. In examples, the full, or partial, discontinuous reception DRX pattern of at least the second radio node UE2 is received at the first radio node UE1 via the physical side-link control channel PSCCH.

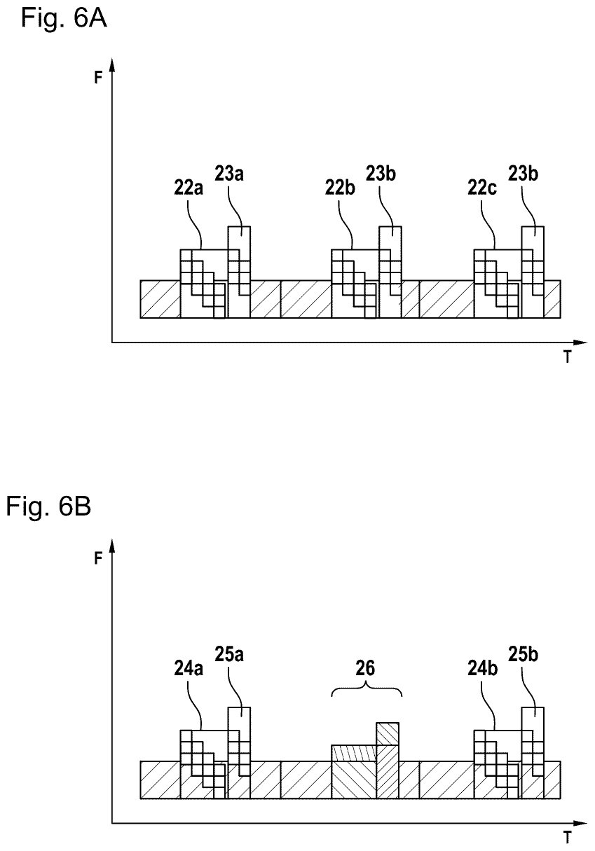

FIG. 6A schematically illustrates a method of a ranging request and response during a DRX cycle according to embodiments on a time-frequency axis. A ranging request SPRS is received (for example, via the PSCCH) from a ranging UE1 at a ranged UE2 during the “RX ON” periods 22a, 22b, and 22c. A ranging response is transmitted from the ranged UE2 during the “TX ON” periods 23a, 23b, 23c. Outside of these times (defined by the DRX cycle of UE2), the ranged UE2 may be in a “sleep mode” where transmission and reception are not possible.

FIG. 6B schematically illustrates a wakeup of a ranged UE2 upon reception of a ranging request from UE1. For example, the ranging request SPRS 24a, 24b functions as a “wake up signal” for the ranged UE2. Upon receiving the ranging request SPRS 24a, 24b, the ranged UE2 wakes up and transmits SPRS 25a, 25b. In time slot 26, the ranged UE2 does not receive an SPRS having an additional function as a “wake up signal”, and therefore the ranged UE2 does not wake up, and an SPRS is not transmitted from UE2 to UE1.

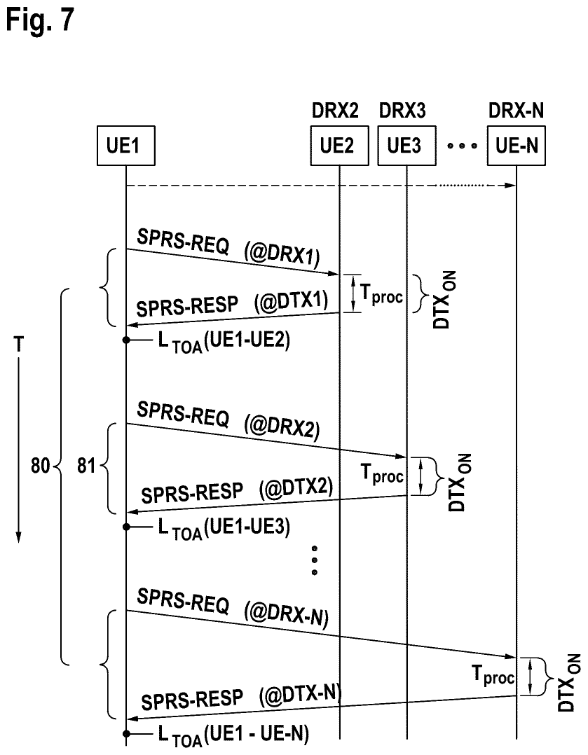

FIG. 7 schematically illustrates a first exemplary ranging signalling scheme. In an example, earlier communication or configuration of the DRX cycles of a plurality of radio nodes to be ranged UE2, UE3, UEN may be obtained by UE1, for example as a PSCCH communication. The first radio node UE1 thus may have prior knowledge of when to transmit SPRS requests containing position indication information to one or more ranged radio nodes UE2, UE3, UEN. In FIG. 7, UE2 operates a DRX cycle DRX2, and UE3 operates a DRX cycle DRX3. UE1 collects information about the DRX cycles of the ranged UEs via control or PSCCH signalling, for example. From bracket 80, it is noted that UE1 has a DRX cycle enabling it to remain awake, or to wake up, before the TX-on time of UE2.

Then, the first radio node UE1 transmits an SPRS-REQ to UE2 during DRX1, the DRX period of the radio node UE2. In an embodiment, the radio node UE2 transmits an SPRS-RESP to UE1. In an embodiment, the radio node UE2 transmits an SPRS-RESP (comprising, for example, a subcarrier comb signal for locating UE2) to UE1 during a DTX period DTX1 of UE2 following a non-zero processing delay at UE2 Tproc. In an example, the ranging first radio node UE1 computes the position of UEL relative to UE2 using the SPRS-RESP signal immediately upon reception of the SPRS-RESP signal from UE2. This provides the most immediate location accuracy of the estimate of UEL to UE2. In another example, UE1 may store a plurality of SPRS signals from a plurality of ranged radio nodes UE2, UE3, UEN and process them on a batch basis. Such an approach may be suitable if radio node UE1 is substantially stationary, and UE2, UE3, UEN are stationary or known to be located in stationary infrastructure items.

According to an embodiment of the first aspect, the method 16 further comprises:
before transmitting the at least one ranging request SPRS to the second radio node UE2, obtaining the discontinuous reception DRX pattern of at least the second radio node at the first radio node UE1; and
transmitting the at least one ranging request SPRS from the first radio node to the second radio node during the active reception period of the second radio node as defined by the discontinuous reception pattern of at least the second radio node.

In this case, if the exact DRX/DTX cycles are known to the ranging UE1, UE1 is configured to send the SPRS during a time when a power saving ranged UE2 is in a DRX active time.

According to an embodiment of the first aspect, the first radio node UE1 transmits a plurality of ranging requests SPRS to the second radio node UE2 in a corresponding plurality of potential active reception periods of the second radio node. For example, this may enable the first radio node UE1 to track or to sample the movement of a ranged radio node UE2 over a period of time in a manner that is energy efficient for UE2.

According to an embodiment of the first aspect, the first radio node UE1 transmits the ranging request SPRS to the second radio node UE2 in a preconfigured active reception period of the second radio node.

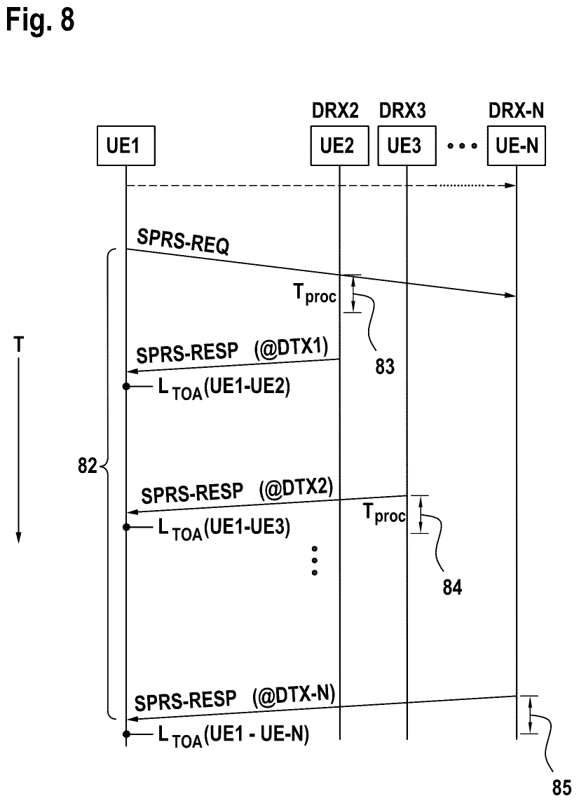

FIG. 8 schematically illustrates a second exemplary ranging signalling scheme. In this variant of the scheme of FIG. 7, the first radio node UE1 is configured to transmit a SPRS-request signal to a plurality of further radio nodes UE2, UE3, UEN during a time slot when UE1 knows that UE2, UE3, UEN are all active and listening. In other words, UE1 is configured to obtain the DRX cycle of a plurality of radio nodes to be ranged, and to transmit an SPRS-request signal to a plurality of further radio nodes UE2, UE3, UEN synchronized to the common DRX cycle of the further radio nodes UE2, UE3, UEN. In an example, earlier communication or configuration of the DRX cycles of a plurality of radio nodes to be ranged UE2, UE3, UEN may be obtained by UE1, for example as a PSCCH communication, or by UE1 monitoring the DRX cycles of the plurality of radio nodes to be ranged UE2, UE3, UEN. In an embodiment, a first radio node UE1 may use a common or dominant DRX cycle for all, or a plurality, of radio nodes in a group assuming that the DRX cycle distribution is obtained or collected by the first radio node UE1.

In the embodiment of FIG. 7, the plurality of radio nodes to be ranged UE2, UE3, UEN may respond to the single SPRS-request signal according to the DTX cycle of each of radio to be ranged UE2, UE3, UEN during a DTX period of each respective ranged UE2, UE3, UEN, after a non-zero processing delay 83, 84, 85. In this case, the first radio node UE1 receives a plurality of SPRS-RESP signals transmitted at unpredictable times.

In an embodiment (not illustrated in FIG. 7), the plurality of radio nodes to be ranged UE2, UE3, UEN may respond to the single SPRS-request signal asynchronously. In this case, the first radio node UE1 receives a plurality of SPRS-RESP signals transmitted at unpredictable times.

According to an embodiment of the first aspect, there is further provided the step of transmitting a wake up signal associated with the at least one ranging request SPRS to the second radio node UE2.

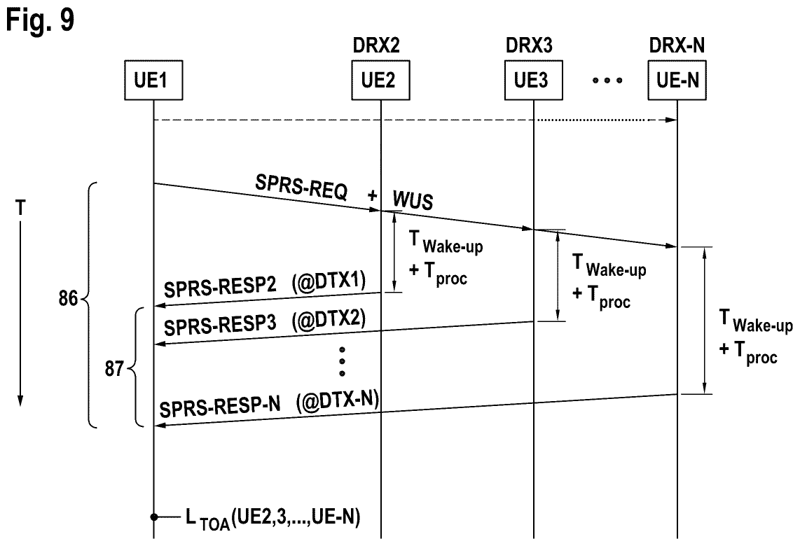

FIG. 9 schematically illustrates a third exemplary ranging signalling scheme. FIG. 9 comprises a signalling diagram showing relevant signal interactions between a first radio node performing ranging UE1 and a plurality of further radio nodes UE2, UE3, UEN. In this third example, UE1 transmits a wakeup signal associated with the SPRS request. In other words, the wakeup signal is concatenated with, joined to, or transmitted in proximity to the SPRS request from the first radio node to the second radio node.

The signal SPRS−REQ+WUS is transmitted from first radio node UE1 to radio nodes UE2, UE3, UEN. Some, or all, of radio nodes UE2, UE3, UEN may be in a sleep mode. Reception of the signal SPRS−REQ+WUS at radio nodes UE2, UE3, UEN respectively causes radio nodes UE2, UE3, UEN to wake up in the time “Twake-up” After a further non-zero processing delay “Tproc”, one, or a subset, of radio nodes UE2, UE3, UEN transmit a SPRS response to the first radio node UE1.

Time range 86 illustrates an embodiment where UE1 remains awake until all SPRS responses are received in time range 87 from radio nodes UE2, UE3, UEN. In an embodiment, the SPRS responses are received from radio nodes UE2, UE3, UEN in sequence. In an embodiment, the SPRS responses are received from radio nodes UE2, UE3, UEN out of sequence, or overlapped in time via different frequency resources of the sidelink. In an embodiment, the position of UE1 relative to radio nodes UE2, UE3, UEN may be computed by UE1 at C_{TOA} (UE2, UE3, UEN). In an alternative, the position of UEL relative to radio nodes UE2, UE3, UEN may be computed by UE1 as individual responses from individual UEs are received. Following transmission of the SPRS responses by UE2, UE3, UEN, the respective UE2, UE3, UEN may re-enter a sleep mode or low power mode. In an embodiment, the sleep mode or low-power mode is defined by the DRX cycle of each of the respective UE2, UE3, UEN ranged radio nodes.

According to an embodiment of the first aspect, the method 16 further comprises:
before generating the at least one ranging request SPRS, obtaining a plurality of discontinuous reception DRX patterns of a plurality of further radio nodes at the first radio node UE1;
computing a ranging request transmission schedule defining a plurality of transmission periods of a plurality of ranging requests SPRS to be transmitted by the first radio node to the plurality of further radio nodes based on the plurality of discontinuous reception DRX patterns of the plurality of further radio nodes;
transmitting the at least one ranging request to at least one of the further radio nodes comprised in the plurality of further radio nodes according to the ranging request transmission schedule; and
receiving a plurality of position reference signals PRS transmitted from at least one of the further radio nodes comprised in the plurality of further radio nodes.

In the case of a large number of radio nodes to be ranged, determining a transmission time for the SPRS request from the first radio node could be difficult. Accordingly, the PSCCH or control channel may be monitored to determine DRX and/or DTX activity of a plurality of radio nodes to be ranged. The first radio node may subdivide the plurality of radio nodes to be ranged, and transmit a plurality of different SPRS requests targeted at different subsets of radio nodes to be ranged. This may also reduce or eliminate the risk of colliding SPRS patterns from different radio nodes to be ranged, and/or enable subsets of the radio nodes to be ranged to have enhanced power saving. For example, if it is determined that a subset of the radio nodes to be ranged are stationary (by monitoring the rate of change in position of previous ranging samples), then the position of these radio nodes may be sampled at much lower time intervals compared to radio nodes that are judged to be in motion. This saves power at the stationary radio nodes.

According to an embodiment of the first aspect, there is provided, before transmitting the at least one ranging request (SPRS) to the plurality of further radio nodes, transmitting a plurality of further wake up signals to the further radio nodes comprised in the plurality of further radio nodes. Accordingly, a plurality of radio nodes can spend a large proportion of time in a sleep mode, and ranging can be performed on-demand of a ranging first radio node UE1.

According to an embodiment of the first aspect, there are the further steps of:
before generating the at least one ranging request SPRS, obtaining a common discontinuous reception DRX pattern for a plurality of further radio nodes at the first radio node UE1;
transmitting the at least one ranging request SPRS to at least one of the further radio nodes comprised in the plurality of further radio nodes according to the common discontinuous reception DRX pattern; and
receiving at least one position reference signal PRS transmitted from at least one of the further radio nodes comprised in the plurality of further radio nodes.
According to an embodiment of the first aspect, there is provided:
before receiving the position reference signal PRS transmitted from the second radio node UE2, obtaining a discontinuous transmission DTX pattern of at least the second radio node at the first radio node UE1; and
receiving the position reference signal PRS transmitted from the second radio node during a period associated with an active transmission period (DTX2) of the second radio node.
For example, the ranging first radio node UE1 may be able to generate a reception schedule of SPRS responses from a plurality of ranged radio nodes if the ranging first radio node UE1 has prior knowledge of the DTX cycles of ranged radio nodes.
According to an embodiment of the first aspect, there is provided the step of:
preventing transmission of the at least one ranging request (SPRS) from the first radio node (UE1) to the second radio node (UE2) during one or more periods when the discontinuous reception (DRX) pattern of the second radio node indicates that the second radio node cannot receive the at least one ranging request of the first radio node.
For example, power efficiency at the ranging first radio node UE1 is also an important consideration if the first radio node is a mobile device. Transmitting ranging requests (SPRS) during times when further radio nodes will not receive the SPRS requests (owing to, for example, the configuration of the DRX cycles of the further radio nodes wastes energy at the first radio node.
According to an embodiment of the first aspect, there are provided the steps of:
transmitting at least one ranging request SPRS from the first radio node UE1 to the second radio node UE2 during an opportunistic discontinuous reception opportunity of the second radio node; and
receiving the position reference signal PRS transmitted from the second radio node, wherein the reception of the ranging request at the second radio node causes the second radio node to transition from a power-saving mode to an active mode; or
after waiting for a predetermined period, signalling to a higher layer that the second radio node has not transitioned from the power-saving mode to the active mode and has not transmitted a position reference signal to the first radio node UE1.

For example, the first radio node UE1 acting as the ranging UE may sends an SPRS during an opportunistic, DRX active time. This means that the first radio node acting as the ranging UE1 may have no prior knowledge of the DRX cycles of one or more of the radio nodes to be ranged. The first radio node UE1 acting as the ranging UE may transmit a SPRS during a time when the first radio node UE1 does not know whether, or not, the SPRS will be successfully received and actioned by one or more of the radio nodes to be ranged. The benefit of this is that no pre-configuration signals need to be transmitted by the first radio node, balanced by the risk that some SPRS requests will not be received by radio nodes UE2, UE3, UEN to be ranged because there is a probability that such radio nodes UE2, UE3, UEN to be ranged may not be in their active DRX period when the opportunistic SPRS request is received.

According to an embodiment of the first aspect, the discontinuous reception pattern defines how a resource of the side link resource pool is occupied by the second radio node UE2. According to an embodiment of the first aspect, the first radio node UE1 is a ranging UE configured to compute a range to at least the second radio node UE2 using the position reference signal PRS transmitted by at least the second radio node. According to an embodiment of the first aspect, the method further comprises receiving, at the first radio node UE1, at least one position reference signal PRS including the at least one position calculation indication transmitted by at least the second radio node UE2 to the first radio node in a resource of a side link resource pool, in response to at least the second radio node receiving the at least one ranging request SPRS.

According to an embodiment of the first aspect at least the second radio node transmits the at least one position reference signal PRS response in the active time of the first radio node UE1, wherein the active time is defined by a discontinuous reception DRX pattern. According to an embodiment of the first aspect, the first radio node UE1 is configured to remain awake until it receives the at least one position reference signal SPRS response of the at least one second radio node UE2. According to an embodiment of the first aspect the first radio node is configured to enter a sleep mode after receiving the at least one position reference signal SPRS response of at least the second radio node.

According to an embodiment of the first aspect, the method further comprises computing, at the first radio node UE1, a position of the second radio node UE2 relative to the first radio node using at least the position reference signal received at the first radio node from the second radio node via the resource of the side link resource pool. According to an embodiment of the first aspect, the method further comprises computing the position of the second radio node UE2 relative to the first radio node UE1 by computing the time of arrival ToA or the time difference of arrival TDoA between the first radio node and the second radio node based on at least the position reference signal.

According to an embodiment of the first aspect, the method further comprises, after computing, at the first radio node UE1, a position of the second radio node UE2 relative to the first radio node, transmitting the computed position of the second radio node relative to the first radio node from the first radio node to the second radio node. According to an embodiment of the first aspect, the first radio node UE1 computes the position of the second radio node UE2 relative to the first radio node during an active period of a discontinuous reception pattern of the first radio node. According to an embodiment of the first aspect, the method further comprises, after computing the position of the second radio node UE2 relative to the first radio node UE1, placing the first radio node into a power saving state.

FIG. 5 schematically illustrates a method of a second radio node.

According to a second aspect, there is provided a wireless communication method 19 of a second radio node UE2, for transmitting a position reference signal to at least a first radio node UE1 based on at least one of a discontinuous reception and/or a discontinuous transmission pattern of at least the second radio node, comprising:
receiving 20 at least one ranging request (SPRS) comprising a position calculation indication from the first radio node during an active reception period of the second radio node, wherein the active reception period is defined by a discontinuous reception pattern of the second radio node; and
transmitting 21 at least one position reference signal (PRS) to the first radio node in a resource of a side link resource pool in response to receiving the ranging request (SPRS) from the first radio node.

For example, the second radio node UE2 may be a radio node of which a first radio node UE1 intends to obtain a position estimate. In a first example, the second radio node UE2 receives an SPRS request comprising a position calculation indication when the second radio node UE2 is in its DRX cycle, and thus awake and able to receive and action the SPRS request. In another example, the second radio node UE2 receives an SPRS request that is also designated as, or concatenated with, a wake-up signal. In further examples, the second (ranged) radio node UE2 may only transmit the SPRS response containing the position reference signal comb during a DTX period of the second radio node UE2, for example.

According to an embodiment of the second aspect, the method 19 further comprises:
receiving, from the first radio node UE1, a request to transmit a discontinuous reception (DRX) pattern of at least the second radio node UE2 to the first radio node;
transmitting the discontinuous reception DRX pattern of at least the second radio node to the first radio node; and
receiving the ranging request SPRS from the first radio node at the second radio node during the active reception period of the second radio node defined by the discontinuous reception pattern of at least the second radio node.

Accordingly, the second radio node UE2 may enable the first radio node UE1 to transmit SPRS requests during times when the second radio node UE2 is expected to be awake, and able to receive the SPRS request. This saves power at the first radio node UE1, because unnecessary SPRS requests are not transmitted from the first to the second radio node.

According to an embodiment of the second aspect, the method 19 further comprises:
before receiving the at least one ranging request (SPRS) from the first radio node (UE1), receiving a wake up signal transmitted by the first radio node to the second radio node (UE2);
upon reception of the wake up signal, changing an operating mode of the second radio node from a sleep mode to an active mode; and
transmitting the at least one position reference signal (PRS) to the first radio node when the second radio node is in the active mode.

Accordingly, the second radio node UE2 may be woken up by the first radio node UE1. This saves power at the first radio node UE1, because unnecessary SPRS requests are not transmitted from the first to the second radio node. Power is saved at the second radio node, because the second radio node may participate in location sampling from the first radio node without being continuously awake.

According to an embodiment of the second aspect, the method 19 further comprises:
after transmitting the at least one position reference signal (PRS) to the first radio node (UE1), changing an operating mode of the second radio node (UE2) from the active mode to the sleep mode.
According to this example, the second radio node UE2 may assume that the SPRS response to the first radio node UE1 has a high probability of reaching the first radio node UE1, and thus not wait for a confirmation that the SPRS response to the first radio node UE1 has been received. This mode may be enabled if the channel conditions, for example RSSI, and/or the Doppler spread, between the first radio node UE1 and the second radio node UE2 are acceptable, for example.
According to an embodiment of the second aspect, the method 19 further comprises:
receiving the ranging request (SPRS) from the first radio node (UE1) during a potential active reception period of the second radio node (UE2);
transitioning, at the second radio node, from a power-saving mode to an active mode upon reception of the ranging request during the potential active reception period; and
transmitting, to the first radio node (UE1) via the resource of the side link resource pool, at least one position reference signal (PRS).

According to an embodiment of the second aspect, the discontinuous reception pattern indicates an active duration, and/or a sleep duration, for a cycle at the second radio node UE2.

According to an embodiment of the second aspect, the at least one ranging request is transmitted from the first radio node (UE1) to the second radio node (UE2) via a resource of a side-link resource pool. According to an embodiment of the second aspect, the at least one ranging request is transmitted from the first radio node (UE1) to at least the second radio node (UE2) via a message in the physical side-link control channel (PSCCH). According to an embodiment of the second aspect, the at least one ranging request is transmitted from the first radio node (UE1) to at least the second radio node (UE2) via a message in the physical side-link broadcast channel (PSBCH).

According to an embodiment of the second aspect, the position reference signal is received by the first radio node (UE1) from at least the second radio node (UE2) via a resource of a side-link resource pool.

According to an embodiment of the second aspect, the position reference signal is received by the first radio node (UE1) from at least the second radio node (UE2) via a message in the physical side-link shared channel (PSSCH).

According to an embodiment of the second aspect, the full, or partial, discontinuous reception (DRX) pattern of at least the second radio node (UE2) is received at the first radio node (UE1) via the physical side-link control channel (PSCCH).

According to an embodiment of the second aspect, the active reception period of the second radio node (UE2) is at least one of the periods defined by the DRX short cycle, the DRX long cycle, or the DRX inactivity timer.

According to an embodiment of the second aspect, the second radio node (UE2) is a power saving or pedestrian UE.

According to an embodiment of the second aspect, the second radio node (UE2) monitors resources of the side link resource pool during an active reception period of the second radio node, and does not monitor resources of the side link resource pool during a sleep duration of the second radio node, wherein the active reception period and/or the sleep duration of the second radio node are partially, or fully defined according to the discontinuous reception and/or a discontinuous transmission pattern of at least the second radio node.

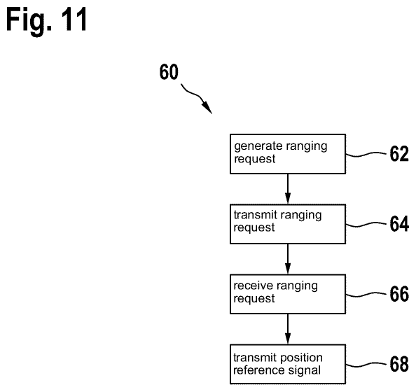

FIG. 11 schematically illustrates an example of a ranging method 60 of at least first and second radio nodes according to a third aspect.

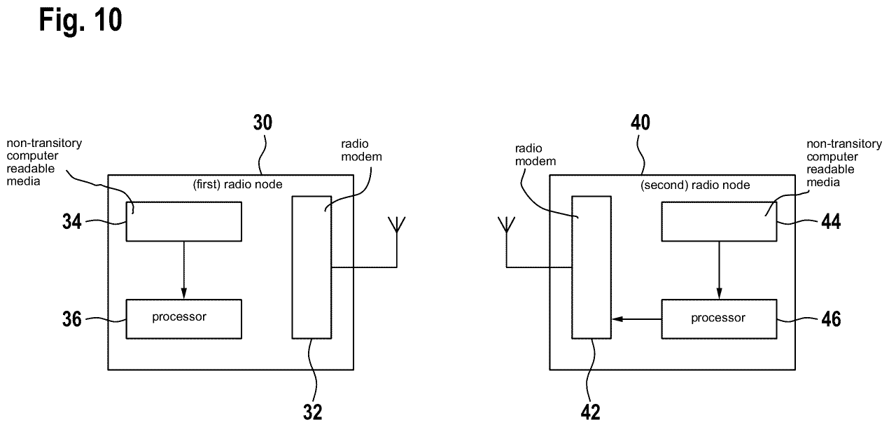

According to the third aspect, there is provided a method 60 for obtaining a position reference signal from at least a second radio node, based on a discontinuous reception pattern of at least the second radio node. The method comprises:
generating 62, at the first radio node UE1, at least one ranging request (SPRS);
transmitting 64, from the first radio node, at least one ranging request (SPRS) comprising at least one position calculation indicator to at least the second radio node such that at least the second radio node receives the at least one ranging request (SPRS) during an active reception period of at least the second radio node, wherein the active reception period of at least the second radio node is defined by a discontinuous reception pattern of at least the second radio node;
receiving 66, at the second radio node, the at least one ranging request (SPRS) from the first radio node during an active reception period of the second radio node, wherein the active reception period is defined by a discontinuous reception pattern of the second radio node; and
transmitting 68, from the second radio node, at least one position reference signal (PRS) to the first radio node in a resource of a side link resource pool in response to receiving the ranging request (SPRS) from the first radio node.
FIG. 10 schematically illustrates an example of first 30 and second 40 radio nodes.

According to a fourth aspect, there is provided a first radio node 30. The first radio node comprises a radio modem 32, non-transitory computer readable media 34 comprising machine readable instructions, and a processor 36 configured to load and to execute the machine readable instructions to cause the first radio node to execute the steps according the first aspect or its embodiments, and thus to transmit a modified position reference signal to a second radio node via at least one side link channel.

The first radio communication node 30 may comprise an input interface configured to obtain input data, for example MAC PDUs. The radio communication node 30 may comprise a power supply. The radio communication node 30 may comprise an antenna coupled to a radio modem 32. The first radio node may support device to device, internet of things, and V2X communications.

According to a fifth aspect, there is provided a second radio node 40. The second radio node 40 comprises a radio modem 42, non-transitory computer readable media 44 comprising machine readable instructions, and a processor 46 configured to load and to execute the machine readable instructions to cause the second radio node to execute the steps according the second aspect.

The second radio node may be substantially as illustrated in FIG. 10, or contain design variations. The second radio node may support device to device, internet of things, and V2X communications.

According to a sixth aspect, there is provided a system 8 for radio communication, comprising a first radio node UE1 and a second radio node UE2. The first radio node UE1 is configured to generate at least one ranging request (SPRS) comprising at least one position calculation indication, and to transmit at least one ranging request (SPRS) including at least one positioning calculation indication to at least the second radio node such that at least the second radio node receives the at least one ranging request (SPRS) during an active reception period of at least the second radio node, wherein the active reception period of at least the second radio node is defined by a discontinuous reception pattern of at least the second radio node. The second radio node UE2 is configured to receive the at least one ranging request (SPRS) comprising the position calculation indicator from the first radio node during an active reception period of the second radio node. The active reception period is defined by a discontinuous reception pattern of the second radio node. The second radio node is configured to transmit at least one position reference signal (PRS) to the first radio node in a resource of a side link resource pool in response to receiving the ranging request (SPRS) from the first radio node.

According to a seventh aspect, there is provided a computer program element comprising machine readable instructions which, when loaded and executed by a processor, cause the processor to perform the method according to the first aspect, or its embodiments.

According to an eighth aspect, there is provided a computer program element comprising machine readable instructions which, when loaded and executed by a processor, cause the processor to perform the method according to the second aspect, or its embodiments.

According to a ninth aspect, there is provided a non-transitory computer readable medium comprising the machine readable instructions defined by one of the seventh or eighth aspects.

According to a tenth aspect, there is provided a vehicle, comprising a radio node according to one of the fourth or fifth aspects.

A radio node may, alternatively, be denoted a radio communication device. The examples provided in the figures and described in the foregoing written description are intended for providing an understanding of the principles of this specification. No limitation to the scope of the present invention is intended thereby. The present specification describes alterations and modifications to the illustrated examples. Only the preferred examples have been presented, and all changes, modifications and further applications to these within the scope of the specification are desired to be protected.

1-51. (canceled)

52. A wireless communication method for a first radio node, for obtaining a position reference signal from at least a second radio node, based on a discontinuous reception pattern of at least the second radio node, comprising the following steps:
generating, at the first radio node, at least one ranging request; and
transmitting the at least one ranging request including at least one position calculation indication to at least the second radio node such that at least the second radio node receives the at least one ranging request during an active reception period of at least the second radio node, wherein the active reception period of at least the second radio node is defined by a discontinuous reception pattern of at least the second radio node.

53. The wireless communication method according to claim 52, further comprising the following steps:
before transmitting the at least one ranging request to the second radio node, obtaining the discontinuous reception pattern of at least the second radio node at the first radio node; and
transmitting the at least one ranging request from the first radio node to the second radio node during the active reception period of the second radio node as defined by the discontinuous reception pattern of at least the second radio node.

54. The wireless communication method according to claim 52, wherein the first radio node transmits the ranging request to the second radio node in a preconfigured active reception period of the second radio node.

55. The wireless communication method according to claim 52, further comprising:
transmitting a wake up signal associated with the at least one ranging request to the second radio node.

56. The wireless communication method according to claim 52, further comprising:
before generating the at least one ranging request, obtaining a common discontinuous reception pattern for a plurality of further radio nodes at the first radio node; and
transmitting the at least one ranging request to at least one of the further radio nodes included in the plurality of further radio nodes, according to the common discontinuous reception pattern; and
receiving at least one position reference signal transmitted from at least one of the further radio nodes included in the plurality of further radio nodes.

57. The wireless communication method according to claim 52, further comprising:
before receiving a position reference signal transmitted from the second radio node, obtaining a discontinuous transmission pattern of at least the second radio node at the first radio node; and
receiving the position reference signal transmitted from the second radio node during a period associated with an active transmission period of the second radio node.

58. The wireless communication method according to claim 53, further comprising:
preventing the transmission of the at least one ranging request from the first radio node to the second radio node during one or more periods when the discontinuous reception pattern of the second radio node indicates that the second radio node cannot receive the at least one ranging request of the first radio node.

59. The wireless communication method according to claim 53, further comprising:
transmitting at least one ranging request from the first radio node to the second radio node during an opportunistic discontinuous reception opportunity of the second radio node; and
(i) receiving the position reference signal transmitted from the second radio node, wherein the reception of the ranging request at the second radio node causes the second radio node to transition from a power-saving mode to an active mode, or (ii) after waiting for a predetermined period, signalling to a higher layer that the second radio node has not transitioned from the power-saving mode to the active mode and has not transmitted a position reference signal to the first radio node.

60. A wireless communication method for a second radio node, for transmitting a position reference signal to at least a first radio node based on at least one of a discontinuous reception and/or a discontinuous transmission pattern of at least the second radio node, the method comprising the following steps:
receiving at least one ranging request including a position calculation indication from the first radio node during an active reception period of the second radio node, wherein the active reception period is defined by a discontinuous reception pattern of the second radio node; and
transmitting at least one position reference signal to the first radio node in a resource of a side link resource pool in response to receiving the ranging request from the first radio node.

61. The wireless communication method of claim 60, further comprising:
receiving, from the first radio node, a request to transmit a discontinuous reception pattern of at least the second radio node to the first radio node;
transmitting the discontinuous reception pattern of at least the second radio node to the first radio node; and
receiving the ranging request from the first radio node at the second radio node during the active reception period of the second radio node defined by the discontinuous reception pattern of at least the second radio node.

62. The wireless communication method of claim 60, further comprising:
before receiving the at least one ranging request from the first radio node, receiving a wake up signal transmitted by the first radio node to the second radio node;
upon reception of the wake up signal, changing an operating mode of the second radio node from a sleep mode to an active mode; and
transmitting the at least one position reference signal to the first radio node when the second radio node is in the active mode.

63. The wireless communication method of claim 62, further comprising:
after transmitting the at least one position reference signal to the first radio node, changing an operating mode of the second radio node from the active mode to the sleep mode.

64. The wireless communication method of claim 60, further comprising:
receiving the ranging request from the first radio node during a potential active reception period of the second radio node;
transitioning, at the second radio node, from a power-saving mode to an active mode upon reception of the ranging request during the potential active reception period; and
transmitting, to the first radio node via the resource of the side link resource pool, at least one position reference signal.

65. A first radio node, comprising:
a radio modem;
non-transitory computer readable media on which are stored machine readable instructions; and
a processor configured to load and to execute the machine readable instructions to cause the first radio node to obtain a position reference signal from at least a second radio node, based on a discontinuous reception pattern of at least the second radio node, including performing the following steps:
generating, at the first radio node, at least one ranging request, and
transmitting the at least one ranging request including at least one position calculation indication to at least the second radio node such that at least the second radio node receives the at least one ranging request during an active reception period of at least the second radio node, wherein the active reception period of at least the second radio node is defined by a discontinuous reception pattern of at least the second radio node.

66. A second radio node, comprising:
a radio modem;
non-transitory computer readable media on which are stored machine readable instructions; and
a processor configured to load and to execute the machine readable instructions to cause the second radio node to transmitting a position reference signal to at least a first radio node based on at least one of a discontinuous reception and/or a discontinuous transmission pattern of at least the second radio node, including performing the following steps:
receiving at least one ranging request including a position calculation indication from the first radio node during an active reception period of the second radio node, wherein the active reception period is defined by a discontinuous reception pattern of the second radio node, and
transmitting at least one position reference signal to the first radio node in a resource of a side link resource pool in response to receiving the ranging request from the first radio node.
